(19) United States
(12) Patent Application Publication
(10) Pub. No.: US 2013/0113637 A1
(43) Pub. Date: May 9, 2013

(54) APPARATUS AND METHOD FOR PROVIDING POSITION INFORMATION, AND USER TERMINAL AND METHOD FOR OUTPUTTING POSITION INFORMATION

(71) Applicants: Cheon Sig SIN, Daejeon (KR); Sang Uk Lee, Daejeon (KR); Do Seob Ahn, Daejeon (KR)

(72) Inventors: Cheon Sig SIN, Daejeon (KR); Sang Uk Lee, Daejeon (KR); Do Seob Ahn, Daejeon (KR)

(73) Assignee: Electronics and Telecommunications Research Institute, Daejeon (KR)

(21) Appl. No.: 13/612,746

(22) Filed: Sep. 12, 2012

(30) Foreign Application Priority Data
Nov. 8, 2011 (KR) 10-2011-0115600

(51) Int. Cl. G08G 1/123

(52) U.S. Cl. 340/989

(57) ABSTRACT

Provided are an apparatus and method for providing position information, and a user terminal and method for outputting position information. The apparatus for providing position information includes a first position information calculator configured to calculate first position information of mobile object using at least three signals received from at least three signal transmission devices, a second position information calculator configured to calculate second position information of the mobile object by mapping the calculated first position information of the mobile object to information on the mobile object's surroundings, and a position information transmitter configured to transmit the calculated second position information of the mobile object to a terminal.

### CLAIM FOR PRIORITY

This application claims priority to Korean Patent Application No. 10-2011-0115600 filed on Nov. 8, 2011 in the Korean Intellectual Property Office (KIPO), the entire contents of which are hereby incorporated by reference.

### BACKGROUND

1. Technical Field

Example embodiments of the present invention relate in general to a method of providing position information, and more particularly, to an apparatus and method for providing position information of mobile object and a user terminal and method for outputting position information.

2. Related Art

As the prevalence of automobiles drastically increases with economic growth, many households are driving out to do their shopping at large shopping centers and department stores. The increase in the number of people who go shopping in vehicles has prompted large shopping centers and department stores to enlarge ground and underground parking lots.

A parking lot of a large building or a general parking lot used by many vehicles has parking areas according to respective floors or areas. When a driver visits a large shopping center or department store in his/her vehicle for some purpose such as shopping, he/she parks his/her vehicle in an above-ground or underground parking lot as directed by a parking guide.

At this time, in order to easily find his/her vehicle when the driver returns to the parking lot after achieving his/her purpose such as shopping, he/she has to somehow take note of the parking spot.

When the driver parks his/her vehicle in a parking lot that he/she frequently uses, he/she can easily find his/her parking spot on the basis of information written in a memo, etc., by accurately recognizing the parking spot. On the other hand, in the case of a parking lot that the driver does not frequently use and is not familiar with, he/she may not be able to easily find his/her parking spot on the basis of information written in a memo and so on.

In particular, a parking lot of a large building is a complex structure in which every floor has a similar layout. For this reason, parking spot numbers in such a parking lot are complicated, for example, “No. 58 in B area on the third basement level,” and it has become more difficult for drivers to remember parking spots. Thus, when the driver returns to the parking lot, it may not be so easy to find his/her vehicle in the large parking area.

To help such drivers, many parking attendants may be employed, which results in an increase in labor costs.

To solve this problem, various kinds of cards that indicate positions in parking lots have been prepared in large shopping centers, etc., such that drivers can draw and hold on to cards corresponding to their parking spots after parking their vehicles. However, a driver may not draw a card, and it may not be easy to find a parking spot in a large parking lot even when the driver has a card.

As solutions to this problem, several methods have been proposed. One of the methods is a parking spot checking method using a remote vehicle starter. In this method, a parking spot of a specific vehicle is indicated using an output signal of a specific remote vehicle starter generated at a specific position in a parking lot having many parking areas, but there are zone limitations.

As another method, in a parking spot checking method using the infrastructure of a specific parking lot, a parking spot is indicated by converting signals of several cameras, sensors, etc. installed in parking areas into usable information. This method requires a complex system and is very costly.

In still another method, after specific meaningful letters of a vehicle parking spot are photographed by a camera, the photographed letters are read, and a driver is informed of the meaning by text or voice. This method is inconvenient because drivers need to consciously take pictures every time they park their vehicles.

As described above, several methods for finding a position of a car have been proposed, but none of them provide a satisfactory solution.

### SUMMARY

Accordingly, example embodiments of the present invention are provided to substantially obviate one or more problems due to limitations and disadvantages of the related art.

Example embodiments of the present invention provide a position information providing apparatus capable of tracking a position of a vehicle in a parking lot.

Example embodiments of the present invention also provide a method of providing position information capable of tracking a position of a vehicle in a parking lot.

Example embodiments of the present invention also provide a user terminal that outputs position information of mobile object.

Example embodiments of the present invention also provide a method for a user terminal to output position information of mobile object.

In some example embodiments, an apparatus for providing position information includes: a first position information calculator configured to calculate first position information of mobile object using at least three signals received from at least three signal transmission devices; a second position information calculator configured to calculate second position information of the mobile object by mapping the calculated first position information of the mobile object to information on the mobile object's surroundings; and a position information transmitter configured to transmit the calculated second position of the mobile object information to a terminal.

Here, the apparatus for providing position information may further include a zone information storage configured to store the zone information on the mobile object's surroundings.

Here, the apparatus for providing position information may further include a surrounding geographic information recognizer configured to collect and provide the zone information on the mobile object's surroundings to the zone information storage.

Here, the first position information calculator may calculate distances between the mobile object and the respective signal transmission devices using times at which the at least three signals are received, and calculate the first position information of the mobile object using the calculated distances.

Here, the zone information on the mobile object's surroundings may include an identification number of a space in which the mobile object is located, and the second position information may include an identification number of a space corresponding to the first position information.

Here, the position information transmitter may transmit the second position information to the terminal using one communication method among Bluetooth, Zigbee, infrared data association (IrDA), wireless fidelity (WiFi) and wireless personal area network (WPAN).

Here, the mobile object may be a vehicle used for transporting passengers or cargo.

Here, the signals may be navigation signals or radio signals including position information on the signal transmission devices.

In other example embodiments, a method of providing position information includes: calculating first position information of mobile object using at least three signals received from at least three signal transmission devices; calculating second position information of the mobile object by mapping the calculated first position information of the mobile object to information on the mobile object's surroundings; and transmitting the calculated second position information of the mobile object to a terminal.

Here, the calculating of the first position information may include calculating distances between the mobile object and the respective signal transmission devices using times at which the at least three signals are received; and calculating the first position information of the mobile object using the calculated distances.

Here, the zone information on the mobile object's surroundings may include an identification number of a space in which the mobile object is located, and the second position information may include an identification number of a space corresponding to the first position information.

In other example embodiments, a user terminal includes: a position information receiver configured to receive a signal including position information on a zone in which a mobile object is located; a distance measurer configured to measure a distance between the user terminal and the mobile object on the basis of the received position information of the mobile object; a determiner configured to determine whether the mobile object is within a predetermined range of the user terminal on the basis of the measured distance; and a notifier configured to output a notification sound indicating that the mobile object is within the predetermined range according to the determination result.

Here, the position information on the zone in which the mobile object is located may include an identification number of a space in which the mobile object is located.

In other example embodiments, a method of outputting position information includes: receiving a signal including position information on a zone in which a mobile object is located; measuring a distance between a user terminal and the mobile object on the basis of the received position information of the mobile object; determining whether the mobile object is within a predetermined range of the user terminal on the basis of the measured distance; and outputting a notification sound indicating that the mobile object is within the predetermined range according to the determination result.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a position information providing apparatus according to an example embodiment of the present invention;

FIG. 2 is a block diagram showing components of a position information providing apparatus according to an example embodiment of the present invention;

FIG. 3 is a flowchart illustrating a process of providing position information on a parked vehicle according to an example embodiment of the present invention;

FIG. 4 is a block diagram showing components of a user terminal that receives vehicle position information from a position information providing apparatus according to an example embodiment of the present invention; and

FIG. 5 is a flowchart illustrating a method for a user terminal to receive vehicle position information from a position information providing apparatus according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in detail with reference to the appended drawings.

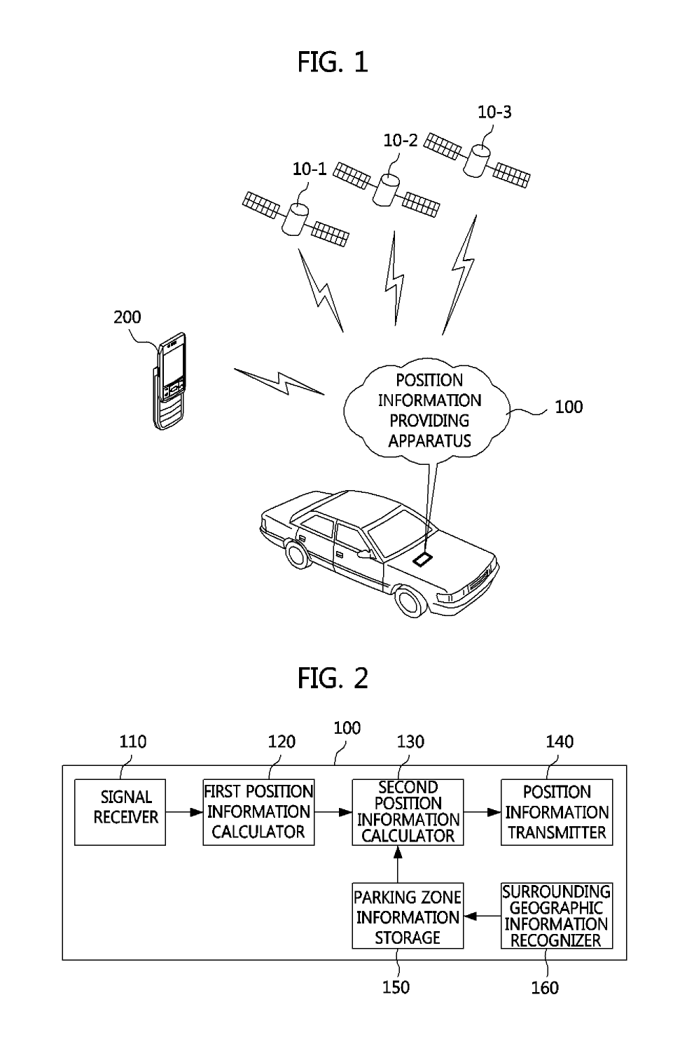

FIG. 1 is a conceptual diagram illustrating a position information providing apparatus according to an example embodiment of the present invention.

Example embodiments of the present invention are intended to provide position information of mobile object. In FIG. 1, an automobile is taken as an example, but the concept of the present invention is not limited to the automobile shown in FIG. 1. In other words, the present invention can be applied to a bicycle, car, motorcycle, train, ship, boat, aircraft, etc., used to transport passengers or cargo.

Referring to FIG. 1, a system for providing position information according to an example embodiment of the present invention may include signal transmission devices 10_1, 10_2 and 10_3, a position information providing apparatus 100 that receives signals transmitted from the signal transmission devices 10_1, 10_2 and 10_3 and calculates the position of a vehicle, and a user terminal 200 that receives the position information calculated by the position information providing apparatus 100.

In the example embodiment of FIG. 1, when a user parks his/her vehicle, turns on the position information providing apparatus 100 installed in the vehicle and then gets out of the vehicle, the position information providing apparatus 100 may receive signals from the signal transmission devices 10_1, 10_2 and 10_3 installed outside the vehicle, for example, in the parking lot, calculate vehicle position information, for example, absolute coordinates of the vehicle, and transmit information on the vehicle position in a parking area, generated by mapping the calculated vehicle position information to previously stored parking zone information, to the user terminal 200.

Although not shown in FIG. 1, the parking lot in which the vehicle is parked consists of at least one floor, and each parking floor consists of a plurality of parking spots created by dividing the parking area. In one parking spot, one vehicle can be parked.

Here, identifiers are given to respective parking spots, and may be a unique identification code of the parking lot, floor information and identification codes given to the parking spots. In other words, an identifier may include information about which parking spot on which floor the corresponding vehicle is located in, information about which parking spot on the corresponding floor the vehicle is located in, and other information, for example, “No. 58 in B area on the third basement level.”

The signal transmission devices 10_1, 10_2 and 10_3 may be installed in the parking lot and transmit signals to the position information providing apparatus 100. There are three signal transmission devices in FIG. 1, but there may be a plurality of signal transmission devices according to the size of a parking lot in which vehicles are parked.

Thus, the position information providing apparatus 100 receives signals from three signal transmission devices when there are three signal transmission devices, but may receive signals from a plurality of signal transmission devices when there is a plurality of signal transmission devices.

An example of the signal transmission devices 10_1, 10_2 and 10_3 may be a navigation satellite such as a pseudolite, a global positioning system (GPS), or a Galileo, which is currently being developed by the European Union (EU) and others. The signal transmission devices 10_1, 10_2 and 10_3 broadcast signals, for example, navigation signals, to the position information providing apparatus 100 in real time through satellite links between the satellites and the ground.

Other examples of the signal transmission devices 10_1, 10_2 and 10_3 are a radio signal transmission device such as a wireless fidelity (WiFi) signal transmission device, a radio frequency identification (RFID) signal transmission device, and an ultra wideband (UWB) signal transmission device.

The signals transmitted by the signal transmission devices 10_1, 10_2 and 10_3 may be navigation signals or radio signals including position information on the signal transmission devices 10_1, 10_2 and 10_3.

The position information providing apparatus 100 may receive the signals from the signal transmission devices 10_1, 10_2 and 10_3 to calculate vehicle position information. As an example, the position information providing apparatus 100 calculates its own current position information on the GPS using a pseudorange of navigation information that is broadcast from at least four navigation satellites through the satellite links between the satellites and the ground.

As another example, the position information providing apparatus 100 may receive navigation signals from navigation signal transmission devices that are synchronized using a precise atomic clock and calculate vehicle position information using triangulation.

Here, triangulation is a method of calculating the position of a target using geometric characteristics of a triangle. In triangulation, pseudoranges, which are distances between a vehicle and at least three navigation signal transmission devices, may be calculated using times at which navigation signals are received from the respective navigation signal transmission devices, and the position of the vehicle may be calculated using the calculated three pseudoranges.

Also, the position information providing apparatus 100 may calculate information on the vehicle position in a parking area by mapping the calculated position information to previously stored parking zone information. For example, the position information providing apparatus 100 may calculate information on the vehicle position in the parking area by mapping the calculated vehicle position information to information on parking zones in the parking lot.

Further, the position information providing apparatus 100 may transmit the information on the vehicle position in the parking area to the user terminal 200. Here, the position information providing apparatus 100 may be in the form of a vehicle navigation system in which a GPS receiver chip is embedded, and may also be in the form of a terminal capable of processing even geographical information.

The user terminal 200 may receive the information on the vehicle position in the parking area from the position information providing apparatus 100. At this time, the user terminal 200 may receive the vehicle position information from the position information providing apparatus 100 through near field communication, for example, Bluetooth, Zigbee, infrared data association (IrDA) and wireless personal area network (WPAN).

Also, the user terminal 200 may receive vehicle position information from the position information providing apparatus 100 through a message service, for example, e-mail, a short message service (SMS) and a multimedia message service (MMS).

In other words, the use terminal 200 is a terminal capable of wireless and wired communication, and may be, for example, a smart phone with WiFi or a key of the vehicle in which an infrared chip is installed.

For example, a case of the user terminal 200 being a key of the vehicle is as follows. The user terminal 200 receives information on a position at which the vehicle is located in a parking area from the position information providing apparatus 100 and stores the position information. When it is determined on the basis of the stored vehicle position information that a distance from the vehicle becomes less than a predetermined distance while a user moves with the user terminal 200, the user terminal 200 may vibrate or output the sound of a bell to inform the user of the position of the vehicle.

In the present invention as described above, the user terminal 200 is provided with vehicle position information from the position information providing apparatus 100, such that a user can easily obtain the information on a position at which his/her vehicle is parked and does not have to worry about the parked vehicle.

Also, in the present invention, a time for movement in a closed space is shortened, and an exposure time to pollution and energy required to find a vehicle are reduced. Thus, the quality of a vehicle operator's life can be improved, and also it is possible to rapidly find his/her parked vehicle. With reference to FIG. 2, components of a position information providing apparatus according to an example embodiment of the present invention will be described below.

FIG. 2 is a block diagram showing components of a position information providing apparatus according to an example embodiment of the present invention.

Referring to FIG. 2, the position information providing apparatus 100 may include a signal receiver 110, a first position information calculator 120, a second position information calculator 130, a position information transmitter 140, a parking zone information storage 150, and a surrounding geographic information recognizer 160.

The signal receiver 110 may receive signals from the signal transmission devices 10_1, 10_2 and 10_3 and provide the received signals to the first position information calculator 120. The signal receiver 110 may receive navigation signals from navigation signal transmission devices, for example, pseudolites, and provide the navigation signals to the first position information calculator 120. Also, the signal receiver 110 may receive radio signals from radio signal transmission devices, for example, WiFi signal transmission devices, RFID signal transmission devices, or UWB signal transmission devices, and provide the received radio signals to the first position information calculator 120.

The first position information calculator 120 may receive the signals from the signal receiver 110 and calculate vehicle position information using the received signals. For example, the first position information calculator 120 may calculate distances between the vehicle and at least three navigation signal transmission devices using times at which the signal receiver 110 receives the respective signals from the navigation signal transmission devices, and calculate the vehicle position information using the calculated distances.

When there is an error in a reception time at which the signal receiver 110 receives a navigation signal from a navigation signal transmission device, for example, when there is a large difference between reception times at which signals are received from at least three navigation signal transmission devices, vehicle position information calculated by the first position information calculator 120 may be inaccurate.

To prevent this, the signal receiver 110 receives respective navigation signals from at least four navigation signal transmission devices and provides the received signals to the first position information calculator 120. The first position information calculator 120 may calculate distances between the vehicle and the respective navigation signal transmission devices using three navigation signals having a small difference in reception time among the at least four navigation signals, and calculate vehicle position information using the calculated distances. Accordingly, the accuracy of the vehicle position information calculated by the first position information calculator 120 may be improved.

The second position information calculator 130 receives coordinate information on the vehicle position from the first position information calculator 120, reads out parking zone information from the parking zone information storage 150, and maps the coordinate information on the vehicle position to the parking zone information read out from the parking zone information storage 150, thereby generating information on the vehicle position in a parking area.

The second position information calculator 130 that has generated the information on the vehicle position in a parking area may transmit the information on the vehicle position in a parking area to the position information transmitter 140 via a wired or wireless network.

The position information transmitter 140 may receive the information on the vehicle position in a parking area from the second position information calculator 130 and provide the received information on the vehicle position in a parking area to the user terminal 200.

For example, the position information transmitter 140 may transmit the information on the vehicle position in a parking area received from the second position information calculator 130 to the user terminal 200 using near field communication such as Bluetooth, WiFi and IrDA.

Also, the position information transmitter 140 may transmit the information on the vehicle position in a parking area received from the second position information calculator 130 to the user terminal 200 using a message service such as e-mail, SMS, or MMS.

The parking zone information storage 150 receives parking-lot map data corresponding to each parking lot from the surrounding geographic information recognizer 160 and stores the received parking-lot map data. The parking-lot map data corresponds to an identification code given to each parking lot consisting of at least one floor.

The parking-lot map data may be floor-specific map information on a parking lot calculated in consideration of terrain and building height information. In other words, the parking-lot map data is information representing insides of floor-specific parking lots consisting of a plurality of parking spots that are created by dividing a parking area and given unique identification codes.

The surrounding geographic information recognizer 160 measures a movement distance and a movement direction of the vehicle and photographs surroundings of the vehicle when the vehicles moves, thereby providing the parking-lot map data to the parking zone information storage 150. To this end, the surrounding geographic information recognizer 160 may have a distance sensor, a direction sensor, a camera module and so on.

The camera module may be plural in number and installed at multiple points on a front, a rear, a side, etc. of the position information providing apparatus 100 to photograph surroundings of the vehicle. The camera module includes a camera sensor, a signal processor, and an image processor. The camera sensor photographs an object ahead and converts the generated optical signal into an electrical signal. The camera sensor may be a charge-coupled device (CCD) sensor. The signal processor converts an analog video signal output from the camera sensor into a digital video signal.

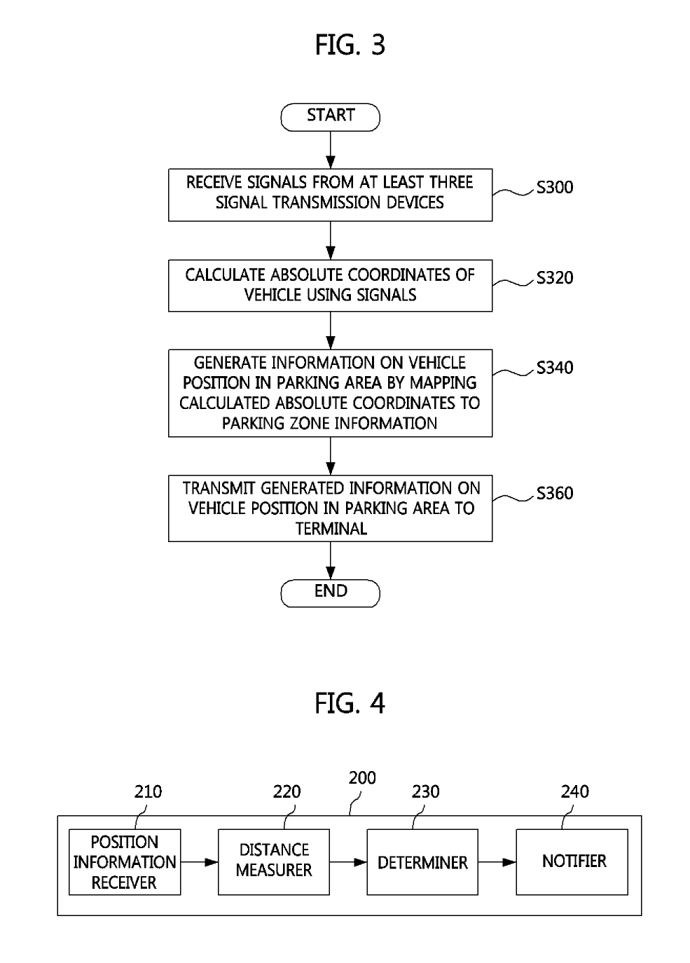

The signal processor may be implemented as a digital signal processor (DSP). The image processor functions to generate screen data for displaying the video signal output from the signal processor. The image processor may cause the video data to conform to the standards of a display. With reference to FIG. 3, a process of providing position information according to an example embodiment of the present invention will be described below.

FIG. 3 is a flowchart illustrating a process of providing position information according to an example embodiment of the present invention.

Referring to FIG. 3, the position information providing apparatus 100 receives signals from the at least three signal transmission devices 10_1, 10_2 and 10_3 installed outside a vehicle (S300). Examples of the signal transmission devices 10_1, 10_2 and 10_3 are a navigation satellite such as a pseudolite, a GPS, and a Galileo, which is currently being developed by the EU and others.

Other examples of the signal transmission devices 10_1, 10_2 and 10_3 are a radio signal transmission device such as a WiFi signal transmission device, an RFID signal transmission device, and a UWB signal transmission device.

The signals transmitted by the signal transmission devices 10_1, 10_2 and 10_3 may be navigation signals or radio signals including position information on the signal transmission devices 10_1, 10_2 and 10_3.

The position information providing apparatus 100 calculates vehicle position information using the signals received from the at least three signal transmission devices 10_1, 10_2 and 10_3 (S320). For example, the position information providing apparatus 100 may receive navigation signals from navigation signal transmission devices, which are synchronized using a precise atomic clock, and calculate vehicle position information using triangulation.

Here, triangulation is a method of calculating the position of a target using geometric characteristics of a triangle. In triangulation, pseudoranges, which are distances between a vehicle and at least three navigation signal transmission devices, may be calculated using times at which navigation signals are received from the respective navigation signal transmission devices, and the position of the vehicle may be calculated using the calculated three pseudoranges.

The position information providing apparatus 100 maps the vehicle position information to previously stored parking zone information, for example, grid information on parking lines in a parking lot, thereby generating information on the vehicle position in a parking area (S340). For example, the position information providing apparatus 100 may calculate information on the vehicle position in a parking area by mapping calculated coordinate information on the position of the vehicle to information on parking zones in the parking lot.

Here, the parking zone information is information representing insides of floor-specific parking lots consisting of a plurality of parking spots that are created by dividing a space and given unique identification codes.

The position information providing apparatus 100 transmits the generated information on the vehicle position in a parking area to the user terminal 200 (S360). At this time, the position information providing apparatus 100 may transmit the vehicle position information to the user terminal 200 using near field communication such as Bluetooth, Zigbee, WiFi, or IrDA, or a message service such as e-mail, SMS, or MMS. With reference to FIG. 4, components of a user terminal that receives vehicle position information from a position information providing apparatus according to an example embodiment of the present invention will be described below.

FIG. 4 is a block diagram showing components of a user terminal that receives vehicle position information from a position information providing apparatus according to an example embodiment of the present invention.

Referring to FIG. 4, the user terminal 200 may include a position information receiver 210, a distance measurer 220, a determiner 230, and a notifier 240.

The position information receiver 210 receives vehicle position information from the position information providing apparatus 100, and provides the received vehicle position information to the distance measurer 220. At this time, the position information receiver 210 may receive the vehicle position information using near field communication such as Bluetooth, Zigbee, WiFi, or IrDA. Also, the position information receiver 210 may receive the vehicle position information using a message service such as e-mail, SMS, or MMS.

The distance measurer 220 measures a distance between the user terminal 200 and the vehicle, thereby generating distance information. First, the distance measurer 220 measures the position of the user terminal 200. Here, the distance measurer may receive position information and time information from a signal transmission device through a position calculation module, for example, a GPS chip, embedded in the user terminal 200, and measure the position of the user terminal 200 using the received position information and time information.

The distance measurer 220 that has measured the position of the user terminal 200 generates distance information by calculating a distance between the user terminal 200 and the vehicle using the position information on the user terminal 200 and the vehicle position information received from the position information receiver 210, and transmits the generated distance information to the determiner 230.

The determiner 230 receives the distance information from the distance measurer 220, determines whether the distance between the user terminal 200 and the vehicle is less than a predetermined distance on the basis of the received distance information, and provides the determination result to the notifier 240.

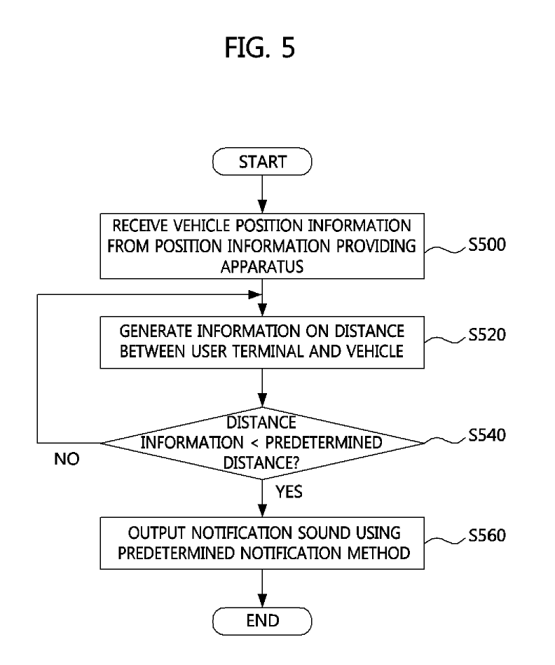

The notifier 240 outputs a notification sound using a predetermined notification method, for example, vibration, sound, etc., according to the determination result of the determiner 230. With reference to FIG. 5, a method for a user terminal to receive vehicle position information from a position information providing apparatus according to an example embodiment of the present invention will be described below.

FIG. 5 is a flowchart illustrating a method for a user terminal to receive vehicle position information from a position information providing apparatus according to an example embodiment of the present invention.

Referring to FIG. 5, the user terminal 200 receives vehicle position information from a position information providing apparatus (S500). Here, the user terminal 200 may receive the vehicle position information using near field communication such as Bluetooth, Zigbee, WiFi, or IrDA. Also, the user terminal may receive the vehicle position information using a message service such as e-mail, SMS, or MMS.

The user terminal 200 that has received the vehicle position information measures a distance from the vehicle, thereby generating distance information (S520). First, the user terminal 200 measures the position of the user terminal 200 itself.

At this time, the user terminal 200 may receive position information and time information from a signal transmission device through an embedded position calculation module, for example, a GPS chip, and measure its own position using the received position information and time information.

Then, the user terminal 200 may generate distance information by measuring a distance from the vehicle using its own position information and the vehicle position information.

The user terminal 200 determines whether the distance from the vehicle is less than a predetermined distance on the basis of the distance information (S540). When it is determined that the distance from the vehicle is less than the predetermined distance, the user terminal 200 outputs a notification sound using a predetermined notification method, for example, vibration, sound, etc. (S560). On the other hand, when it is determined that the distance from the vehicle is not less than the predetermined distance, the user terminal 200 measures a distance from the vehicle, thereby generating distance information (S520).

The above-described apparatus and method for providing position information according to example embodiments of the present invention receive signals from at least three signal transmission devices installed outside a vehicle to calculate vehicle position information, calculate the information on the vehicle position in a parking area by mapping the calculated vehicle position information to previously provided parking zone information, and transmit the information on the vehicle position in a parking area to a user terminal, such that a user can be provided with the vehicle position information.

When the above-described apparatus and method for providing position information according to example embodiments of the present invention are used, vehicle position information is provided to a user terminal, such that a driver can easily and conveniently find his/her parking spot. Also, it is possible to prevent a vehicle operator from wasting his/her time to find his/her vehicle because the user does not remember the position of his/her vehicle in an indoor or outdoor parking lot having remote or complex parking areas.

The need for these effects will increase due to continuous deterioration of human memory in this aging era, and drastic increase in the sizes of parking lots caused by a continuous increase in the number of vehicles.

In addition, by shortening a time for movement in a closed space, it is possible to reduce an exposure time to pollution and energy required to find a vehicle, such that the quality of a vehicle operator's life can be improved.

While example embodiments of the present invention and their advantages have been described in detail, it should be understood that various changes, substitutions and alterations may be made herein without departing from the scope of the invention.

What is claimed is:

1. An apparatus for providing position information of mobile object, comprising:
a first position information calculator configured to calculate first position information of the mobile object using at least three signals received from at least three signal transmission devices;
a second position information calculator configured to calculate second position information of the mobile object by mapping the calculated first position information of the mobile object to zone information on the mobile object's surroundings; and
a position information transmitter configured to transmit the calculated second position information of the mobile object to a terminal.

2. The apparatus of claim 1, further comprising a zone information storage configured to store the zone information on the mobile object's surroundings.

3. The apparatus of claim 2, further comprising a surrounding geographic information recognizer configured to collect and provide the zone information on the mobile object's surroundings to the zone information storage.

4. The apparatus of claim 1, wherein the first position information calculator calculates distances between the mobile object and the respective signal transmission devices using times at which the at least three signals are received, and calculates the first position information of the mobile object using the calculated distances.

5. The apparatus of claim 1, wherein the zone information on the mobile object's surroundings includes an identification number of a space in which the mobile object is located, and
the second position information includes an identification number of a space corresponding to the first position information.

6. The apparatus of claim 1, wherein the position information transmitter transmits the second position information to the terminal using one communication method among Bluetooth, Zigbee, infrared data association (IrDA), wireless fidelity (WiFi) and wireless personal area network (WPAN).

7. The apparatus of claim 1, wherein the mobile object is a vehicle used for transporting passengers or cargo.

8. The apparatus of claim 1, wherein the signals are navigation signals or radio signals including position information on the signal transmission devices.

9. A method of providing position information of mobile object performed by a position information providing apparatus, comprising:
calculating first position information of the mobile object using at least three signals received from at least three signal transmission devices;
calculating second position information of the mobile object by mapping the calculated first position information of the mobile object to zone information on the mobile object's surroundings; and
transmitting the calculated second position information of the mobile object to a terminal.

10. The method of claim 9, wherein the calculating of the first position information includes:
calculating distances between the mobile object and the respective signal transmission devices using times at which the at least three signals are received; and
calculating the first position information of the mobile object using the calculated distances.

11. The method of claim 9, wherein the zone information on the mobile object's surroundings includes an identification number of a space in which the mobile object is located, and
the second position information includes an identification number of a space corresponding to the first position information.

12. A user terminal, comprising:
a position information receiver configured to receive a signal including position information on a zone in which a mobile object is located;
a distance measurer configured to measure a distance between the user terminal and the mobile object on the basis of the received position information of the mobile object;
a determiner configured to determine whether the mobile object is within a predetermined range of the user terminal on the basis of the measured distance; and
a notifier configured to output a notification sound indicating that the mobile object is within the predetermined range according to the determination result.

13. The user terminal of claim 12, wherein the position information on the zone in which the mobile object is located includes an identification number of a space in which the mobile object is located.

14. A method of outputting position information performed by a user terminal, comprising:
receiving a signal including position information on a zone in which a mobile object is located;
measuring a distance between the user terminal and the mobile object on the basis of the received position information of mobile object;
determining whether the mobile object is within a predetermined range of the user terminal on the basis of the measured distance; and
outputting a notification sound indicating that the mobile object is within the predetermined range according to the determination result.
